(19) United States
(12) Patent Application Publication
(10) Pub. No.: US 2009/0211807 A1
(43) Pub. Date: Aug. 27, 2009

(54) Implement Having a Strain Relief Means For a Connection Cable

(76) Inventor: Dieter Kremsler, Spiegelberg (DE)

Correspondence Address: ROBERT W. BECKER & ASSOCIATES, 707 HIGHWAY 333, SUITE B, TIJERAS, NM, 87059-7507, US

(21) Appl. No.: 12/388,379

(22) Filed: Feb. 18, 2009

(30) Foreign Application Priority Data
Feb. 27, 2008 (DE) 10 2008 011 461.8

(51) Int. Cl. H02G 3/30

(52) U.S. Cl. 174/662

(57) ABSTRACT

An implement having an electrical drive and a connection cable for supplying electrical energy to the implement. A strain relief mechanism is provided for the connection cable and includes a retention element, on the outer periphery of which is formed a receiver for the connection cable. A securing element is provided for the connection cable and holds the connection cable on the retention element.

The instant application should be granted the priority date of Feb. 27, 2008 the filing date of the corresponding German patent application 10 2008 011 461.8.

### BACKGROUND OF THE INVENTION

The present invention relates to an implement having a strain relief means for a connection cable.

For implements having an electrical drive, a connection plug is generally provided that can be disposed on a short cable section, and to which a connection cable can be connected. During operation, pulling or tensile forces can act upon the connection between the two cables, and can lead to a disconnection thereof. To prevent this, strain relief means are known for connection cables that absorb pulling forces during operation and thus prevent the pulling forces from acting on the connection.

For example, holding members are known as strain relief means about which a connection cable can be looped. The connection cable can be held on the holding member by clamping or by friction. To prevent the connection cable from sliding off of the holding member when it is not stressed, the holding member must be adapted to the diameter of the connection cable.

It is an object of the present invention to provide an implement having a strain relief means for a connection cable according to which the strain relief means is suitable for connection cables having varying diameters, and has a straightforward construction.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of one exemplary embodiment of the inventive implement in the form of a blower,

FIG. 2 is a partial perspective illustration of the strain relief means of the blower of FIG. 1,

FIG. 3 is a side view of the strain relief means of FIG. 2,

FIG. 4 is a perspective, sectioned view of the strain relief means of the blower,

FIG. 5 is an enlarged, sectioned view of the strain relief means,

FIG. 6 is a side view of the strain relief means with the housing shown partially sectioned, and

FIG. 7 is a perspective view of the strain relief means and only one half shell of the housing of the blower.

### SUMMARY OF THE INVENTION

The implement of the present application, which has an electrical drive and a connection cable for supplying electrical energy to the implement, comprises a strain relief means for the connection cable, wherein the strain relief means includes a retention element, on the outer periphery of which is formed a receiving means, and a securing element for the connection cable, wherein the securing element holds the connection cable on the retention element.

The securing element ensures that the connection cable cannot become disconnected or detached from the retention element, especially when no pulling forces act on the connection cable. Therefore, pursuant to the present invention, no clamping of the connection cable to the retention element is required. Consequently, with the implement of the present application it is possible to dispose connection cables having varying diameters on the retention element. In this connection, the receiving means advantageously extends at least over half of the outer periphery of the retention element. Thus, the connection cable is looped about the retention element over a peripheral angle of at least 180°. As a result, it is possible to fixate the connection cable on the retention element by friction. The pulling forces that during operation occur at the connection cable are completely absorbed by the retention element. The securing element merely prevents the connection cable from slipping off of the retention element. Due to the fact that only very slight forces act on the securing element, the securing element can have a simple construction as well as a low weight, so that the weight of the implement is not noticeably increased by the securing element.

The securing element advantageously rests on the connection cable on that outer side that faces away from the retention element. In this connection, in the conventional operating position of the implement, the securing element advantageously acts from below against the connection cable, and thus acts counter to the force of gravity. A straightforward configuration results if the securing element has a holding plate that rests against the connection cable. In this connection, the holding plate advantageously has a receiving trough for the connection cable. As a result, the position of the connection cable, especially for connection cables having reduced diameters, is defined by the holding plate.

The securing element is advantageously pivotably mounted. As a result, for connection cables having varying diameters one can ensure in a simple manner that the securing element always rests against the connection cable. To be able to fix the connection cable and the retention element, it is merely necessary to pivot the securing element away. This results in an easy operation. A straightforward configuration of the securing element results if the securing element is monolithically formed with at least one pivot pin, via which the securing element is pivotably mounted in a housing of the implement. As a result, no additional components are required for the support of the securing element. A straightforward construction results.

To ensure that the securing element always rests against the connection cable, the securing element can be mounted in a resilient manner. Consequently, the securing element does not have to be pressed against the connection cable by the operator; rather, due to the resilience, the securing element automatically assumes the abutment position against the connection cable. The securing element is advantageously monolithically formed with a resilient part. As a result, additional spring elements can be eliminated. A straightforward configuration results if the spring part is embodied as a resilient bar that projects into a housing of the implement and is supported in the housing. Due to the fact that the resilient bar is disposed at least partially within the housing of the implement, it is protected from becoming dirty and from becoming damaged. The resilient bar is advantageously disposed entirely within the housing. A straightforward configuration results if the securing element is made of polymeric material.

The strain relief means is advantageously disposed in a recessed area in a housing of the implement. In this connection, the recessed area can be formed as a deepening or depression in the housing; advantageously, however, the recessed area is embodied as an opening on the housing, so that the strain relief means is accessible from both sides. As a result, the direction in which the connection cable is guided away from the strain relief means can be individually selected by the operator. The retention element is expediently provided with an end plate that laterally delimits the receiving means formed on the outer periphery of the retention element. Consequently, a lateral sliding of the connection cable from the retention element is prevented in a simple manner without the need for additional components.

To enable a straightforward fixation of the connection cable on, and release from, the retention element, an entry opening for the connection cable can be formed between the end plate and that wall of the recessed area that is across from the end plate. As a result, pursuant to the present application, the connection cable does not have to be threaded about a holding member, but rather can be guided as a loop through the entry opening and can be placed over the retention element. At least one passage is advantageously formed between the entry opening and the receiving means that is formed on the outer periphery of the retention element; the passage is at least partially closed off by the securing element. Thus, the securing element prevents the connection cable from accidentally passing into the entry opening through the passage and thus becoming detached from the retention element.

At least one reinforcing strut, which extends approximately in the longitudinal direction of the retention element, is advantageously disposed on the outer periphery of the retention element. The reinforcement strut on the one hand reinforces the retention element, so that greater forces can be absorbed. At the same time, the reinforcing strut, which extends transverse to the receiving means, prevents a movement of the connection cable in its longitudinal direction. As a result, the pulling forces in the connection cable that can be absorbed by the strain relief means are increased. The reinforcement strut can furthermore be embodied in such a way that it also laterally narrows the receiving means, resulting in a clamping effect of the connection cable at the retention element.

Further specific features of the present invention will be described in detail subsequently.

### DESCRIPTION OF SPECIFIC EMBODIMENTS

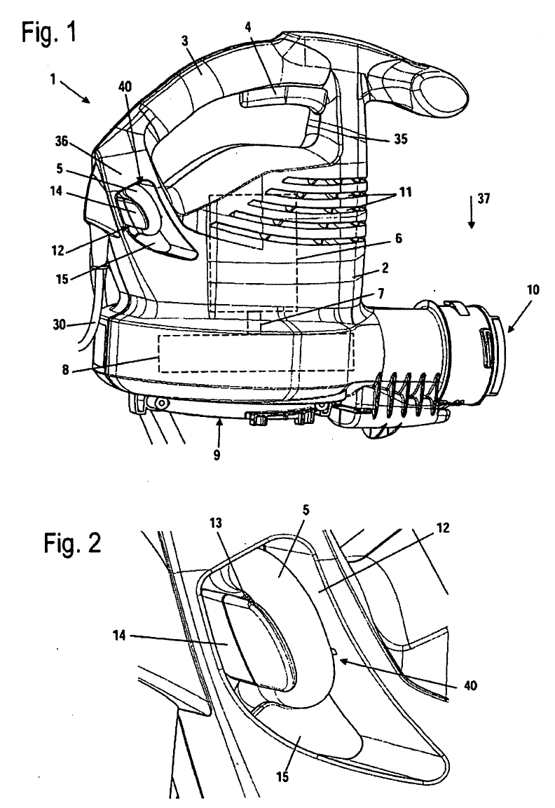

Referring now to the drawings in detail, in FIG. 1 a portable, manually-guided blower 1 is shown as an exemplary embodiment for an implement 1. The blower 1 can be converted to form a suction or vacuum device. The blower 1 has a housing 2 on which is secured an upper handle 3. The upper handle 3 is formed on the half shells of the housing 2 and is connected to the housing 2 via a front connector portion 35 and a rear connector portion 36. Mounted on the upper handle 3 is a gas throttle 4 for operating a drive motor 6 that is disposed in the housing 2. The drive motor 6 is embodied as an electric motor and, via a drive shaft 7, rotatingly drives a blower wheel or impeller 8. The impeller 8 draws in operating air from an intake opening 9 and blows it out through a discharge opening 10.

During operation of the implement as a blower 1, a blower tube is secured to the discharge opening 10, and an intake grating is secured at the intake opening 9. If the blower 1 is to be operated as a suction device, a suction tube is secured to the intake opening 9 and a collection bag for material that is suctioned up is secured to the discharge opening 10. To supply the drive motor 6 with cooling air, a plurality of cooling air openings 11 are provided on the housing 2. To supply the drive motor 6 with electrical energy, a connection cable 30 is secured to the housing 2. The connection cable 30 is connected via a non-illustrated plug connector with a further connection cable 5. In this connection, the connection cable 5 is advantageously an extension cable. The connection cable 5 is held on a strain relief means or mechanism 40. The strain relief means 40 serves to absorb tensile or pulling forces that act on the connection cable 5 so that they are not conveyed further to the connection cable 30 at the plug connection, in order in this way to prevent the plug connection between the connection cable 5 and 30 from being accidentally disconnected.

The strain relief means 40 is disposed in a recessed area 12 in the housing 2 that is embodied as an opening in the rear connector portion 36. The strain relief means 40 is thereby accessible from both sides of the housing.

As shown in FIG. 2, the strain relief means 40 includes a retention element 13 that extends into the recessed area 12 transverse to the longitudinal direction of the recessed area. Disposed at the free end of the retention element 13 is an end plate 14 that extends laterally beyond the retention element 13. The strain relief means 40 furthermore includes a securing element 15 that rests against the connection cable 5 on that outer side that faces away from the retention element 13. In this connection, the securing element 15 extends into the recessed area 12 from the underside, in other words, form that side that in the effective direction 37 of the force of gravity (FIG. 1) lies at the bottom.

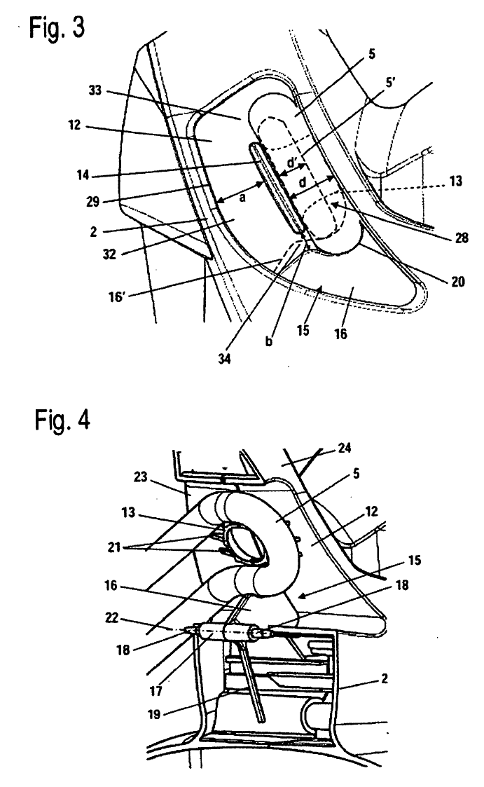

As shown in FIG. 3, the retention element 13 extends approximately over half of the width of the recessed area 12. An entry opening 32 for the connection cable 5 is formed between the end plate 14 and that wall 29 of the recessed area 12 that is disposed across from the retention element 13. The connection cable 5, in the form of a loop, can be inserted through the entry opening 32. A first passage 33 is formed laterally of the end plate 14 on that side that in the effective direction 37 of the force of gravity is at the top, and a second passage 34 is formed on that side that in the effective direction 37 lies at the bottom. By means of these passages 33 and 34, the two portions of the connection cable 5 that define the loop can be pressed over the end plate 14 toward the retention element 13. Formed on the outer periphery of the retention element 13 is a receiving means 28 for the connection cable 5 that is laterally delimited by the end plate 14.

The distance a between the wall 29 of the recessed area 12 and the end plate 14 is greater than the diameter d of the connection cable 5, so that the connection cable can easily be inserted through the entry opening 32. In the installed position of the connection cable 5 shown in FIG. 3, a holding plate 16 of the securing element 15 rests against the connection cable 5. As shown, the holding plate 16 has a receiving trough 20 that is rounded and that is pressed against the connection cable 5. Formed between the end plate 14 and the holding plate 16 of the securing element 15 is a spacing b that is significantly less than the diameter d of the connection cable 5. The passage 34 is to a large extent closed off by the securing element 15, so that the connection cable 5 cannot pass through the passage 34 and cannot come loose from the retention element 13.

Shown in dashed lines in FIG. 3 on the retention element 13 is a connection cable 5′ that has a reduced diameter d′. When a connection cable 5′ having a reduced diameter d′ is provided, the securing element 15 pivots further upwardly, so that the holding plate 16′ is disposed in the position shown by dashed lines in FIG. 3 and rests against the connection cable 5′. As shown in FIG. 3, the distance between the end plate 14 and the holding plate 16′ is less than the diameter d′ of the connection cable 5′, so that also with connection cables 5′ having a reduced diameter d′ an accidental or unintended disconnection of the connection cable 5′ from the retention element 13 is prevented.

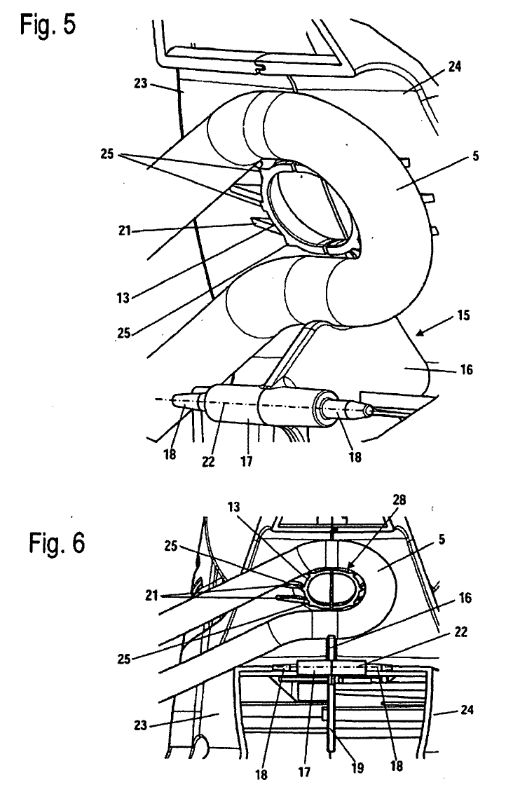

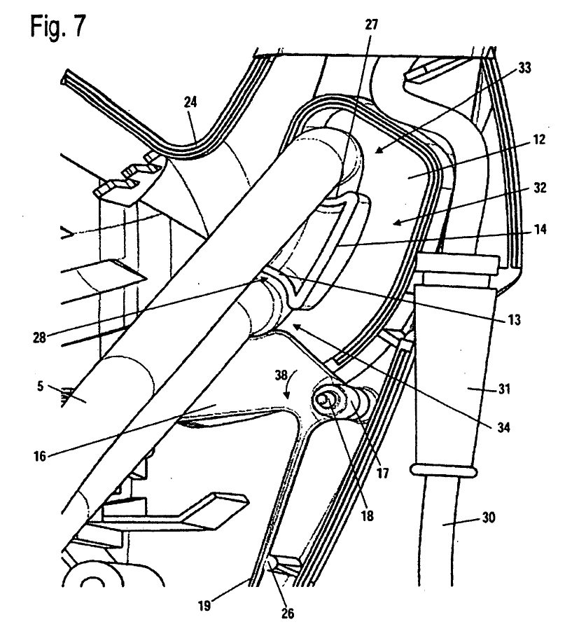

FIG. 4 shows the configuration of the securing element 15. The securing element 15 includes a pivot shaft 17 that is formed on the holding plate 16. Formed on the pivot shaft 17, on both sides, are pivot pins 18 via which the securing element 15 is mounted in the housing 2 of the blower 1 so as to be pivotable about a pivot axis 22. In this connection, the holding plate 16 extends through a slot in the housing 2 that extends between two half shells 23, 24 (e.g. FIGS. 5 and 6) that form the housing 2, the holding plate 16 extending from the pivot shaft 17 into the recessed area 12. Formed on the pivot shaft 17 is a resilient bar 19 that extends downwardly from the pivot shaft and is disposed entirely in the interior of the housing 2. The resilient bar 19 rests against the pin or lug 26 of the housing 2 (see FIG. 7). As a result, the holding plate 16 is elastically mounted in the direction toward the connection cable 5. The pivot axis 22 of the securing element 15 is oriented parallel to the longitudinal direction of the recessed area 12 and is disposed in the interior of the housing 2 on that side of the recessed area 12 that is opposite the retention element 13.

As shown in FIG. 4, the retention element 13 is formed on the housing 2 and is embodied as a hollow cylinder. Disposed on the outer periphery of the retention element 13 are reinforcement struts or ribs 21 that extend in the longitudinal direction of the retention element 13 and in the longitudinal direction of the recessed area 12.

The reinforcement struts 21 are shown more clearly in FIG. 5. The reinforcement struts 21 have an approximately triangular configuration, and thus reduce the receiving means 28 at the base of the receiving means. As also shown in FIG. 5, the outer periphery of the retention element 13 is provided with elevations or raised portions 25 that can have a triangular or rectangular cross-sectional configuration. The elevations 25 extend in the longitudinal direction of the retention element 13 and transverse to the longitudinal direction of the connection cable 5, and thus improve the fixation of the connection cable 5 on the retention element 13. As also shown in FIG. 5, the housing 2 is composed of two half shells 23 and 24 that are divided perpendicular to the pivot axis 22. Half of the retention element 13 is respectively formed on each of the half shells 23 and 24 of the housing 2. The securing element 15 is held between the two half shells 23 and 24 of the housing 2. The securing element 15, as is the case with the half shells 23 and 24 of the housing 2, is advantageously made of a polymeric material.

As shown in particular in FIG. 6, the elevations 25 are embodied as an extension of the reinforcement struts 21. As also shown in FIG. 6, the connection cable 5 is looped over significantly more than half of the retention element 13, and advantageously over approximately three fourths of its periphery. The connection cable 5 is consequently held on the retention element 13 by friction. If a pulling force occurs on one of the ends of the connection cable 5, the connection cable is securely looped about the retention element 13 and the frictional forces that occur prevent the connection cable 5 from slipping on the outer periphery of the retention element 13. The securing element 15 serves merely to secure the connection cable 5 on the retention element 13. However, the securing element 15 need not absorb any pulling forces of the connection cable 5.

As shown in FIG. 7, the retention element 13 merges into the end plate 14 via a rounded portion 27. The end plate 14 extends or projects beyond the retention element 13 and thus laterally delimits the receiving means 28. The connection cable 30, which is held on the housing 2, is guided in a cable sleeve 31 where it exits the housing 2.

For the fixation of the connection cable 5, the connection cable is pressed as a loop through the entry opening 32 and through the passages 33 and 34 over the end plate 14 and onto the retention element 13. In so doing, the holding plate 16 is pivoted downwardly in the direction of the arrow 38 in order to release the passage 34 for the connection cable 5. A corresponding pivoting of the holding plate 16 is also effected for the disconnection of the connection cable 5. By means of the resilient bar 19, the holding plate 16 is spring loaded or biased against the connection cable 5 and during operation holds the connection cable 5 on the retention element 13.

The receiving means 28 extends along the entire outer periphery of the retention element 13, so that the connection cable 5 can be pressed over the retention element 13 from both sides into a portion of the receiving means 28.

The specification incorporates by reference the disclosure of German priority document 10 2008 011 461.8 filed Feb. 27, 2008.

The present invention is, of course, in no way restricted to the specific disclosure of the specification and drawings, but also encompasses any modifications within the scope of the appended claims.

What I claim is:

1. An implement having an electrical drive and a connection cable (5, 30) for supplying electrical energy to said implement, comprising:
a strain relief means (40) for said connection cable (5), wherein said strain relief means (40) includes a retention element (13), and wherein a receiving means (28) for said connection cable (5) is formed on an outer periphery of said retention element (13); and
a securing element (15) for said connection cable (5), wherein said securing element (15) holds said connection cable (5) on said retention element (13).

2. An implement according to claim 1, wherein said securing element (15) is adapted to rest on said connection cable (5) on an outer side thereof that faces away from said retention element (13).

3. An implement according to claim 1, wherein said securing element (15) is provided with a holding plate (16) that rests against said connection cable (5).

4. An implement according to claim 3, wherein said holding plate (16) has a receiving trough (20) for said connection cable (5).

5. An implement according to claim 1, wherein said securing element (15) is adapted to be pivotably mounted.

6. An implement according to claim 5, which further comprises a housing (2), wherein at least one pivot pin (18) is monolithically formed on said securing element (15), and wherein said securing element (15) is pivotably mounted in said housing (2) of said implement via said at least one pivot pin (18).

7. An implement according to claim 1, wherein said securing element (15) is adapted to be mounted in a resilient manner.

8. An implement according to claim 7, wherein said securing element (15) is monolithically formed with a resilient part.

9. An implement according to claim 8, which further includes a housing (2), wherein said resilient part is embodied as a resilient bar (19), and wherein said resilient bar (19) projects into said housing (2) of said implement and is supported in said housing (2).

10. An implement according to claim 1, wherein said securing element (15) is made of polymeric material.

11. An implement according to claim 1, which further includes a housing (2), wherein said strain relief means (40) is disposed in a recessed area (12) provided in said housing (2) of said implement, and wherein said retention element (13) extends transversely into said recessed area (12).

12. An implement according to claim 11, wherein said retention element (13) is provided with an end plate (14) that laterally delimits said receiving means (28) that is formed on said outer periphery of said retention element (13).

13. An implement according to claim 12, wherein an entry opening (32) for said connection cable (5) is formed between said end plate (14) and a wall (29) of said recessed area (12) that is disposed across from said end plate (14).

14. An implement according to claim 13, wherein at least one passage (33, 34) is formed between said entry opening (32) and said receiving means (28) that is formed on said outer periphery of said retention element (13), and wherein said at least one passage (33, 34) is at least partially closed off by said securing element (15).

15. An implement according to claim 1, wherein at least one reinforcing strut (21) is disposed on said outer periphery of said retention element (13), and wherein said at least one reinforcement strut (21) extends approximately in a longitudinal direction of said retention element (13).
